(19) United States
(12) Patent Application Publication
(10) Pub. No.: US 2003/0041004 A1
(43) Pub. Date: Feb. 27, 2003

(54) On-line auction marketplace for services

(76) Inventors: Travis J. Parry, Boise, ID (US); Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/933,954

(22) Filed: Aug. 21, 2001

(51) Int. Cl. G06F 17/60

(52) U.S. Cl. 705/37

(57) ABSTRACT

An implementation of a technology, described herein, for selling and purchasing of services via a real-time electronic auction. At least one implementation of the invention, described herein, is an on-line auction (such as an Internet auction), where services are the subject of such auction. In at least one implementation, the auctioned services are “proximity-independent.” With such services, they need not be performed in a region proximal to the party requesting the service. This abstract itself is not intended to limit the scope of this patent. The scope of the present invention is pointed out in the appending claims.

### TECHNICAL FIELD

This invention generally relates to a technology for selling and purchasing of services via a real-time electronic auction.

### BACKGROUND

When performing a service, typically the physical presence of the service provider performing such service is required to be at or near (i.e., proximity) the one receiving such service. Herein, these services are called “proximity-dependent” services. Examples of such services include plumbing, construction, auto repair, babysitting, lawn care, dog grooming, medical care, dentistry, and the like.

However, there are some services where proximity is not important. The location of the service provider (in relation to the one being served) may not matter. Alternatively, one may desire to have a service performed in a location local to the service provider, but distant from the one being served. In other words, the services need not be performed in a region proximal to the party requesting the service. Herein, these types of services are called “proximity-independent” services. Examples of such services include (by way of example and not by limitation): advertising in movie houses, advertising in local & regional media (publications, radio, television, and the like), Web page design, patent application drafting, graphic design, computer programming, legal services, and the like.

### Proximity-Independent Services

Movie Advertisements

Often before a motion picture presentation begins, the awaiting audience is entertained by images projected onto a movie screen. The images sometimes include trivia questions and quick puzzles, particularly those that are film-related. Many times, the images include (by way of example and not by limitation) advertisements for local establishments, such as restaurants, manicurists, hair stylists, auto service, insurance, and such. The advertisements may be almost anything, even help wanted ads.

Typically, such advertisement is done on a local level. They typically advertise local establishments because the movie theater's local sales force can efficiently sell such ads locally. Also, local businesses typically wish to focus their advertising dollars to their local customer base.

Conversely, such advertising may be on a multi-regional (including national and international) level—particularly when the local movie house is part of a multi-regional (including national and international) chain or organization of such movie houses.

Unfortunately, the unaffiliated or independent movie house is unable to tap into revenues from multi-regional (including national and international) advertising because such a movie house lacks resources to seek out and secure such revenue streams and/or such a movie house lacks the clout necessary to obtain such advertising at an attractive rate.

More unfortunately still, the multi-regional (including national and international) advertiser is unable to place their directed advertising in a venue, like the independent/unaffiliated movie house, where their market sits alone in a dark room with nothing to do but view their ad. This is a more personal form of advertising of which an advertiser may not avail itself without dedicating large-scale resources (like a field sales forces). The multi-regional (including national and international) advertiser does not have the resources to seek out and secure advertising at such venues.

Other Services

Like movie advertising, other services are proximity-independent. Multi-regional (including national and international) businesses often wish to direct their advertising to the readers of local & regional publications. Examples of such publications include a city newspaper or a magazine focusing on a particular region, such as the Pacific Northwest.

When a business needs a Web page designed, it does not matter where the page designer is physically located. The designer can load the designed Web page from nearly anywhere. Likewise, a graphic designer may design printed material (e.g., brochures, business cards, reports, etc.) from most anywhere.

For many legal services, it is unimportant where the attorney is physically located while providing the service. This is particularly true for the drafting of legal documents or giving advice. An example of such a service is the drafting of patent applications.

In addition to advertising, the brokering of stocks, bonds, commodities, and the like is another proximity-independent services. When the service is performed, the broker may be nearly anywhere.

Traditionally, services—such as these proximity-independent services—are not sold to the highest bidder via an on-line auction. Instead of services, only goods are typically bought and sold via such auctions.

### Traditional Physical Auctions

Traditional physical auctions—where people gather in an auction hall to bid—may include either goods or services. Of course, the auctioning of goods at traditional auctions is commonplace. Christie's™ and Sotherby's™ are auction houses that are famous for selling noteworthy, expensive, famous, and infamous items (i.e., goods).

It is not uncommon for services to auction off at charity auction. Individuals and business may offer their services for sale in an auction format with the proceeds going towards a charitable cause. In these instances, the auctioned services are those that must be performed at or near the one receiving the services. In other words, these services are proximity-dependent.

In addition, the parties to a proximity-dependent service must arrange for a mutually acceptable time frame for the services to be performed. The time frame and delivery are not typically agreed upon (or specified) at the time of the bidding.

### Conventional Goods-Based On-line Auctions

There are many Internet sites for conventional on-line auctions (e.g., Internet auctions). One of the most well known is Ebay™ (www.ebay.com). All of these conventional on-line auctions are goods-based, which means that goods, rather than services, are auctioned.

On such auctions, nearly anyone in the on-line world can post a physical item (i.e., a good) for-sale and others bid on that item in an auction-type style. Typically, the highest bidder can purchase the item from the seller at a price equal to their winning bid. In these instances, the seller and buyer arrange for delivery of such goods to the buyer. Typically, the goods are shipped via the U.S. Postal Service or another equivalent service.

### Need for Services-Based On-line Auctions

Services are not the subject of conventional on-line auctions. One reason for this may be that services typically require a physical presence of a service provider to perform such service. In other words, these services are proximity-dependent.

Since the Internet is boundary-less and regionally anonymous by its nature, the travel required to perform a service is cumbersome or economically infeasible. Furthermore, it is difficult for one to find and identify an entity willing to perform a particular service within a particular region.

However, there are some services where proximity is not important. These are proximity-independent services.

Accordingly, there is a need for a real-time auction (such as an Internet auction), where services are the subject of such auction. There is a particular need where the services need not be performed in a region proximal to the party requesting the service—i.e., where services are proximity-independent. Advertising is a prime example of a proximity-independent service where such a need exists.

### SUMMARY

Described herein is a technology for selling and purchasing of services via a real-time electronic auction.

At least one implementation of the invention, described herein, is an on-line auction (such as an Internet auction), where services are the subject of such auction. In at least one implementation, the auctioned services are “proximity-independent.” With such services, they need not be performed in a region proximal to the party requesting the service.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a schematic block diagram showing an on-line services auction marketplace in accordance with an implementation of the invention herein.

FIG. 2 is a schematic block diagram showing the on-line services auction marketplace in accordance with another implementation of the invention herein.

FIG. 3 is a flow chart illustrating a methodological implementation in accordance with an implementation of the invention herein.

FIG. 4 is an example of a computing operating environment capable of implementing an implementation (wholly or partially) of the invention herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of the present invention, thereby better explaining the present invention. Furthermore, for ease of understanding, certain method steps are delineated as separate steps; however, these separately delineated steps should not be construed as necessarily order dependent in their performance.

The following description sets forth one or more exemplary implementations of an On-line Auction Marketplace for Services. The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of an On-line Auction Marketplace for Services may be referred to as an “exemplary services auction marketplace.”

### Exemplary On-Line Auction Marketplace

The one or more exemplary implementations, described herein, of the present claimed invention may be implemented (in whole or in part) by a services auctioning system 100 and/or by a computing environment.

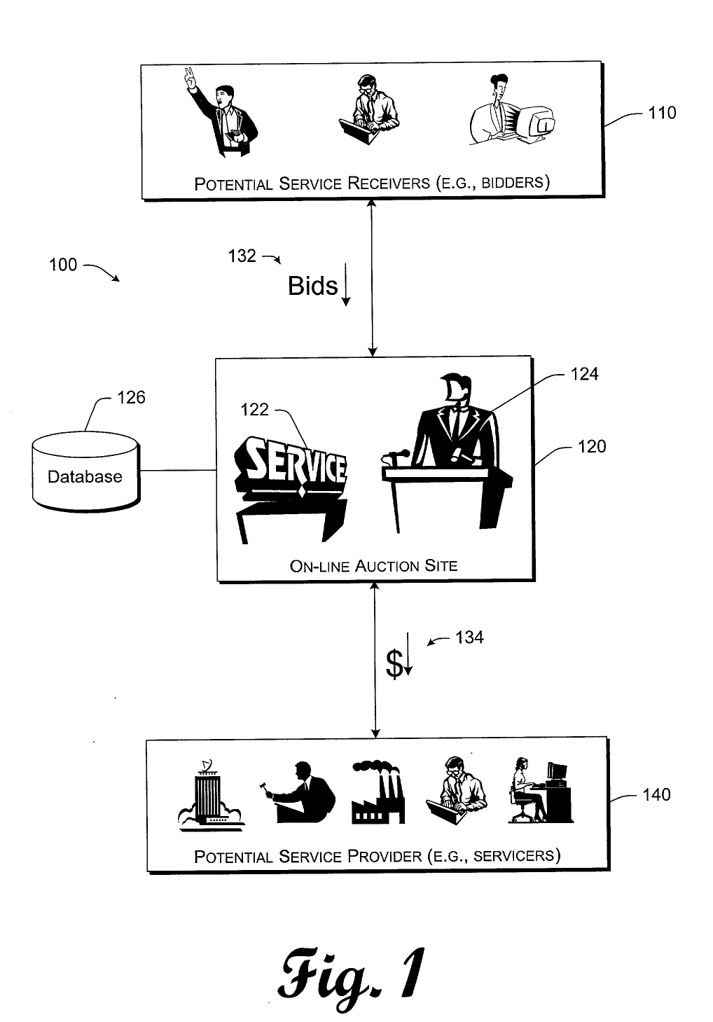

FIG. 1 shows the services auctioning system 100, which is an implementation of the exemplary services auction marketplace. The system may also be called an on-line auction marketplace or Internet auction. In such marketplace, services 122 are posted for-sale, bid on, and sold via auction (as represented by a virtual auctioneer 124 in FIG. 1). The services are auctioned off.

Typically, potential service providers 140 place services 122 onto the “virtual” auction block of an on-line auction site 120. By way of example (and not limitation), a service provider 140 may be a movie house with advertising space, a newspaper with advertising space, a graphic designer, an attorney, computer programmer, and the like.

Potential service receivers 110 bid (e.g., bids 132) for the services 122. By way of example (and not limitation), a service receiver 110 may be a corporation wishing to better advertise their products, a business in need of a better designed Web page, an inventor who would like to file a patent application on his invention, and the like.

The on-line auctioneer 124 (as part of the on-line auction site 120) auctions the service. Typically, the highest bidder amongst the potential service receivers 110 wins the auction. With payment (e.g., payment 134), the highest bidder may receive the service 122 from the potential service providers 140. Data regarding such transactions are stored in a database 126.

In at least one implementation, the auctioned services 122 are “proximity-independent,” which are those services that need not be performed in a region proximal to the party requesting the service.

With proximity-independent services, the nearness (i.e., proximity) of the one requesting the service and the performance of the service is not important. In such instances, the location of the service provider (in relation to the one being served) may not matter. In other instances, one may desire to have a service performed in a location local to the service provider, but distant from the one being served. Examples of such services includes (by way of example and not by limitation) advertising in movie houses, advertising in local & regional media (publications, radio, television, the Internet, and the like), Web page design, patent application drafting, graphic design, computer programming, legal services, and the like.

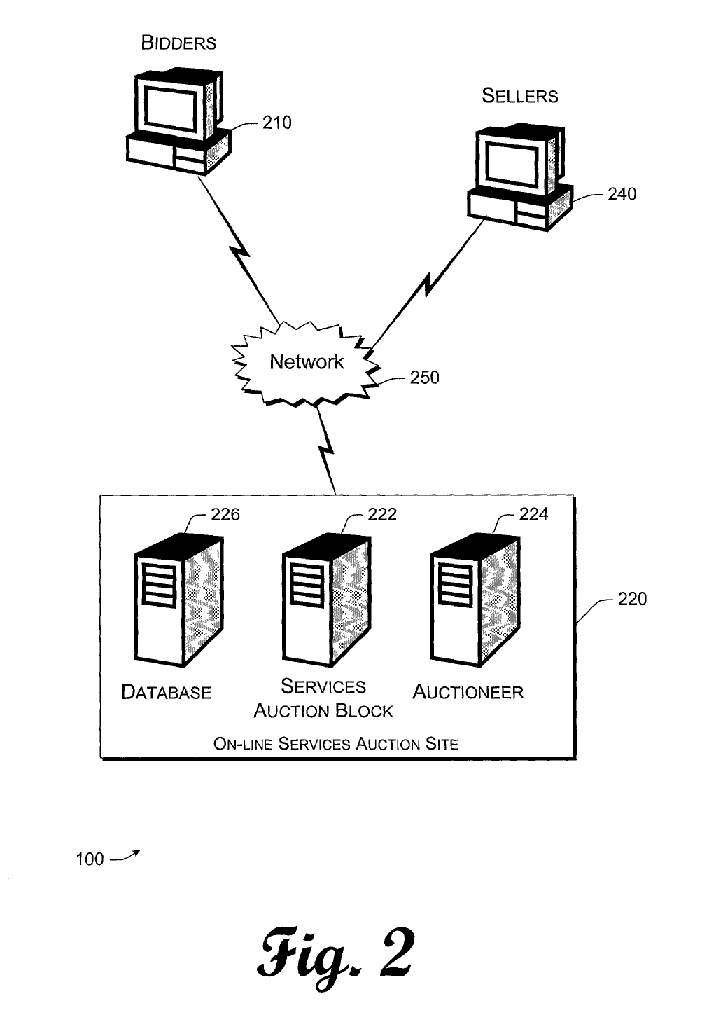

FIG. 2 illustrates the same services auctioning system 100 of FIG. 1, but in terms of computing components. As shown in FIG. 2, the services auctioning system 100 includes one or more coupled servers (e.g., servers 222-226) hosting an on-line services auction Web site 220. Services are auctioned via the Web site 220 using, for example, a services-auction-block server 222 for managing services for bid, an auctioneer server 224 for managing the bidding process, and a database 226 for tracking and organizing information related to such auction.

Sellers 240 place their services with the on-line services auction Web site 220 to sell to the highest bidder. Bidders 210 (e.g., potential buyers) bid on the available services. With the highest bid on a particular service, a potential buyer may purchase the service at the bid price.

Typically, these sellers and buyers utilize client computers on a network 250—such as the Internet.

Real-Time Auction

The auction process of the exemplary services auction marketplace happens in real-time. There is little or no delay between the bidding on a service item and the updating of the bid status on that item.

Furthermore, there may be real-time performance of a service once there is a winning bid. Real-time performance of the service may mean, for example, immediate or near immediate performance upon the official determination of the winning bid. Alternatively, the service may not be performed immediately, but the order to perform the service may be placed immediate (or soon) upon the official the official determination of the winning bid.

If the service was advertising, for example, a bidder may have a prepared and pre-screened advertisement that the service provider can display immediately (or soon after) upon the official determination that the bidder is the winner.

As a result, the auction for a service to be preformed at a specific moment in time may be run until just before the moment. Therefore, the service provider may be able to maximize their return by leaving the item available for bid until just before required performance.

Reversing Roles of Bidders and Sellers

Alternatively, bidding and selling may be reversed. In this scenario, the bidders 210 of the exemplary services auction marketplace are potential service providers (e.g., servicers 140 of FIG. 1), rather than those wishing to receive a service. Of course, the “sellers” 240 of the exemplary services auction marketplace are those wishing to receive a service (e.g., service receivers 110 of FIG. 1), rather potential service providers. In this instance, the “sellers” are seeking to buy rather than actually sell.

In this alternative arrangement, the “seller” 240 places their need for a service “on the auction block” of server 222. This service may be generally or narrowly defined. By way of example (and not limitation), a “seller” 240 may be a corporation wishing to better advertise their products, a business in need of a better designed Web page, an inventor who would like to file a patent application on his invention, and the like.

In this alternative arrangement, the bidder 210 is one that believes that they can provide the desired service. The bidders bid the right to perform the service “on the auction block” at the bid price. By way of example (and not limitation), a bidder 210 may be a movie house with advertising space to sell, a newspaper with advertising space to sell, an Internet portal with space to sell, a graphic designer, an attorney, computer programmer, and the like.

Compensation for Auction Marketplace

Typically, the entity providing the on-line services auction site (e.g., 220) would be compensated for facilitating the services auction. Examples of compensation models include the following (provided for examples and not limitation):

a fixed fee paid by the one selling the service, one buying the service, or both;

a fee based upon a portion of the auction price (initial, reserve, and/or final price) which is paid by the one selling the service, one buying the service, or both;

a membership fee;

advertising revenue;

any combination of the above.

Alternatively, the entity providing the on-line services auction site may be a service provider (e.g., 140). This service may be part of a business practice. That is, an entity (such as a television station or movie house) may operate the web site where any potential bidder could bid on various services—for example, advertising time slots.

### Examples of Other Proximity-Independent Services

The following is a list of examples of other proximity-independent services that may be auctioned using at least one implementation of the exemplary services auction marketplace. This non-exhaustive list includes examples of such services by way of examples and not limitation:

advertising in movie houses

advertising in local & regional media (publications, radio, television, the Internet, and the like)

Web page design

patent application drafting

graphic design

computer programming

legal services

brokerage and financial services;

Internet access service

Internet Web page hosting

Internet domain name hosting

Internet E-mail hosting

Internet data storage hosting

### Methodological Implementation of the Exemplary Services Auction Marketplace

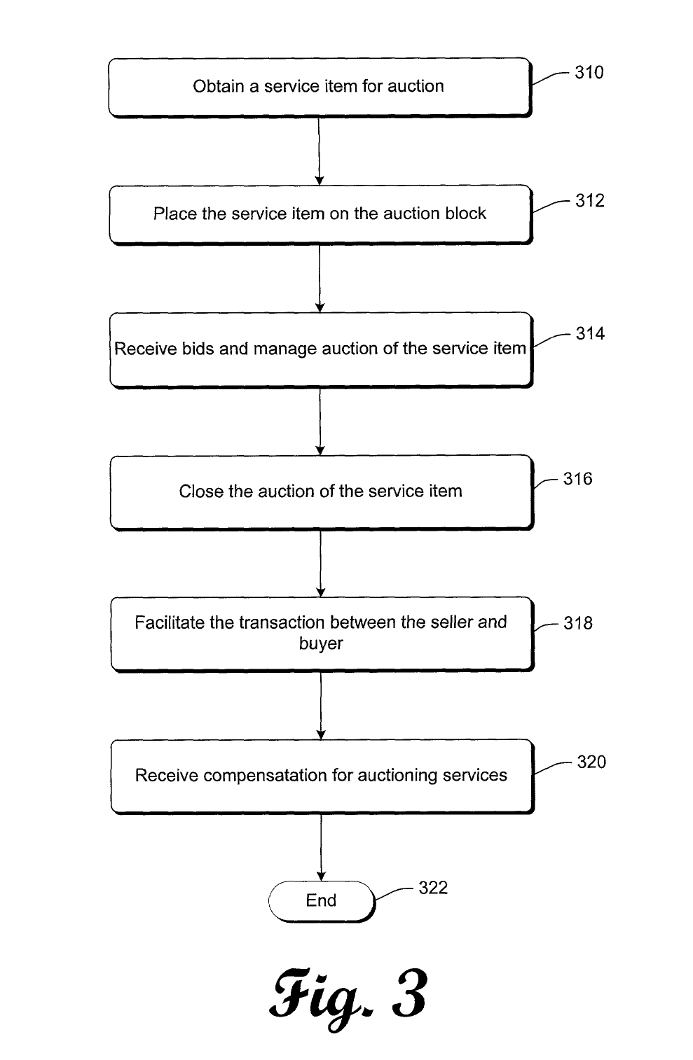

FIG. 3 shows methodological implementation of the exemplary services auction marketplace performed by the services auctioning system 100 (or some portion thereof). This methodological implementation may be performed in software, hardware, or a combination thereof.

At 310 of FIG. 3, the services auctioning system 100 obtains a “service item.” A service item is either an entry of a service to-be-provided or a request for a service to-be-received. Typically, the system obtains the service items by providing a Web site, which may be publicly accessed via the Internet. Users may register general and specific information about themselves and about the service item to be auctioned.

At 312, the system places the service item up for auction. Typically, this means that databases are updated to reflect the availability of the service item and its current status information. A page may be statically or dynamically generated for a user of the Web site.

At 314, the system receives bids and manages the auction for the service item. At 316, the system closes the item. Typically, this is done after a given period of time or if a maximum bid it reached. At that point, the highest bidder wins the right to the service item. If the item is a service, it will be automatically provided to the winning bidder with compensation coming from an open account or on credit. Alternatively, the winning bidder has the right to buy the service at the winning bid. If the item is a request for a service, then the winning bidder is the lowest bidder. That bidder will sell its service at the winning bid price.

At 318, the system facilitates the transaction between the buyer and seller. The system may encourage communication between them. It may act as a third party for exchange of monies for services.

If the system is functioning as a “middle man” to facilitate the auction of other parties, then it may receive compensation at block 320. At 320, the system receives compensation for providing its auction services to the seller and buyer. Examples of the differing kinds of compensation are provided above. At 322, the process ends.

### Common Rating System for Services

The exemplary services auction marketplace may include a mechanism to provide a common rating scale for services to facilitate the buying and selling of services via the on-line auction. The services may be ones that have a highly variable valuation (e.g., a “time-sensitive” value). The common rating scale may be provided so that the value (and, in particular, the time-sensitive nature of the value) of such services may be specified. Thus, this gives a common unit of measurement for perceived valuation of a service.

### Exemplary Computer Architecture

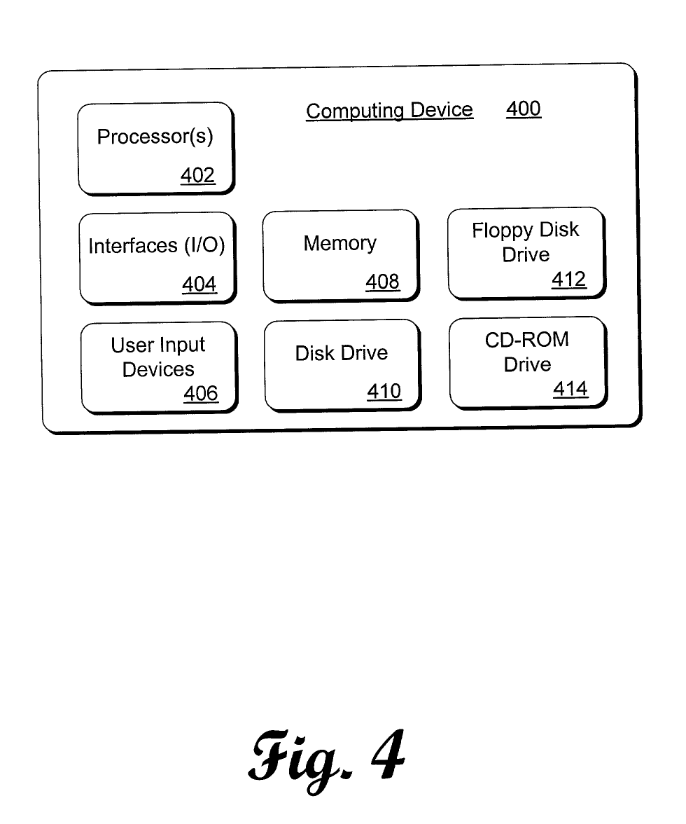

FIG. 4 illustrates various components of an exemplary computing device 400 that can be utilized to implement the exemplary services auction marketplace. Computer 400 includes one or more processors 402, interfaces 404 for inputting and outputting data, and user input devices 406. Processor(s) 402 process various instructions to control the operation of computer 400, while interfaces 404 provide a mechanism for computer 400 to communicate with other electronic and computing devices. User input devices 406 include a keyboard, mouse, pointing device, or other mechanisms for interacting with, and inputting information to computer 400.

Computer 400 also includes a memory 408 (such as ROM and/or RAM), a disk drive 410, a floppy disk drive 412, and a CD-ROM drive 414. Memory 408, disk drive 410, floppy disk drive 412, and CD-ROM drive 414 provide data storage mechanisms for computer 400. Although not shown, a system bus typically connects the various components within the computing device 400.

### Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for facilitating the on-line auction of one or more services, the method comprising:
obtaining a service item for auction;
managing an on-line auction for the service item, wherein the managing comprises:
receiving on-line bids for the service item;
closing the on-line auction for the service item;
indicating one or more winning bids and one or more winning bidders.

2. A method as recited in claim 1 further comprising receiving compensation from one or more members of a group selected from an auction bidder, an auction participant, a service seller, a service buyer, a service item placer, and a member of an auction.

3. A method as recited in claim 1 further comprising facilitating real-time provision of the service item for the one or more winning bidder, wherein the real-time provision of the service item occurs proximally near in time to the closing.

4. A method as recited in claim 1 further comprising providing one or more computing systems that perform the obtaining and managing.

5. A method as recited in claim 1, wherein the obtaining further comprises receiving information related to the service item via a communications network.

6. A method as recited in claim 1, wherein the managing further comprises receiving real-time bids for the service item via a communications network.

7. A method as recited in claim 1, wherein the service item is a service.

8. A method as recited in claim 1, wherein the service item is a proximity-independent service.

9. A method as recited in claim 1, wherein the service item is a proximity-independent service selected from a group consisting of.
advertising;
advertising in movie houses;
advertising in broadcast media;
advertising on the radio;
advertising on television;
advertising on an Internet Web site;
advertising in printed publications;
Web page design;
patent application drafting;
brokerage and financial services;
shipping;
graphic design;
computer programming;
legal services;
Internet access service;
Internet Web page hosting;
Internet domain name hosting;
Internet E-mail hosting;
Internet data storage hosting.

10. A method as recited in claim 1, wherein the service item is a proximity-independent service that is intended to be performed for the one or more winning bidders.

11. A method as recited in claim 1, wherein the service item is a service that is intended to be performed by the one or more winning bidders.

12. A method as recited in claim 1, wherein the service item is a proximity-independent service that is intended to be performed by the one or more winning bidders.

13. An on-line marketplace for auctioning services, the marketplace comprising:
a services auction-block computing system configured to obtain a service item for auction;
an auctioneer computing system configured to manage an on-line auction for the service item.

14. A marketplace as recited in claim 13, wherein the auctioneer computing system is further configured to:
receive on-line bids for the service item;
close the on-line auction for the service item;
indicate one or more winning bids and one or more winning bidders.

15. A marketplace as recited in claim 13, wherein the service item is a service.

16. A marketplace as recited in claim 13, wherein the service item is a proximity-independent service.

17. A marketplace as recited in claim 13, wherein the service item is a proximity-independent service selected from a group consisting of:
advertising;
advertising in movie houses;
advertising in broadcast media;
advertising on the radio;
advertising on television;
advertising on an Internet Web site;
advertising in printed publications;
Web page design;
shipping;
patent application drafting;
graphic design;
brokerage and financial services;
computer programming;
legal services;
Internet access service;
Internet Web page hosting;
Internet domain name hosting;
Internet E-mail hosting;
Internet data storage hosting.

18. A marketplace as recited in claim 13, wherein the service item is a proximity-independent service that is intended to be performed for the one or more winning bidders.

19. A marketplace as recited in claim 13, wherein the service item is a service that is intended to be performed by the one or more winning bidders.

20. A marketplace as recited in claim 13, wherein the service item is a proximity-independent service that is intended to be performed by the one or more winning bidders.

21. A computer-readable medium having computer-executable instructions that, when executed by a computer, performs a method for facilitating the on-line auction of one or more services, the method comprising:
obtaining a service item for auction;
managing an on-line auction for the service item, wherein the managing comprises:
receiving on-line bids for the service item;
closing the on-line auction for the service item;
indicating one or more winning bids and one or more winning bidders.

22. A computer-readable medium as recited in claim 21, wherein the method further comprising facilitating real-time provision of the service item for the one or more winning bidder, wherein the real-time provision of the service item occurs proximally near in time to the closing.

23. A computer-readable medium as recited in claim 21, wherein the service item is a service.

24. A computer-readable medium as recited in claim 21, wherein the service item is a proximity-independent service.

25. A computer-readable medium as recited in claim 21, wherein the service item is a proximity-independent services elected from a group consisting of:
advertising;
advertising in movie houses;
advertising in broadcast media;
advertising on the radio;
shipping;
advertising on television;
advertising on an Internet Web site;
advertising in printed publications;
Web page design;
patent application drafting;
graphic design;
computer programming;
legal services;
brokerage and financial services;
Internet access service;
Internet Web page hosting;
Internet domain name hosting;
Internet E-mail hosting;
Internet data storage hosting.

26. A computer-readable medium as recited in claim 21, wherein the service item is a proximity-independent service that is intended to be performed for the one or more winning bidders.

27. A computer-readable medium as recited in claim 21, wherein the service item is a service that is intended to be performed by the one or more winning bidders.

28. A computer-readable medium as recited in claim 21, wherein the service item is a proximity-independent service that is intended to be performed by the one or more winning bidders.
